(19) United States
(12) Patent Application Publication
(10) Pub. No.: US 2003/0236660 A1
(43) Pub. Date: Dec. 25, 2003

(54) Data recording-reproduction device

(75) Inventors: Satoshi Yoshimura, Osaka (JP); Masanao Yoshida, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 10/460,394

(22) Filed: Jun. 13, 2003

(30) Foreign Application Priority Data
Jun. 19, 2002 (JP) 2002-177869

(51) Int. Cl. G10L 19/00

(52) U.S. Cl. 704/201

(57) ABSTRACT

The present invention provides a data recording-reproduction device comprising a manipulation button 10 having a recording button, reproduction button and an INDEX button. A control microcomputer 7 prepares a file name including a file ID number and an index number in response to the manipulation of the recording button, starts to write digital data, and thereafter updates the index number included in the file name in response to the manipulation of the INDEX button to continue to write the digital data with a new file name. Furthermore, the control microcomputer starts to read digital data having a selected file name in response to the manipulation of the reproduction button, and updates the index number included in the file name in response to the subsequent manipulation of the INDEX button followed by reading digital data having a new file name.

### FIELD OF THE INVENTION

The present invention relates to data recording-reproduction devices, such as IC recorders and digital video cameras, which are adapted for data recording operation for converting voice or image generated continuously on a real time-base axis to digital data and writing the digital data to a memory, and data reproduction operation for reading the digital data written to the memory and reproducing the data as voice or image.

### BACKGROUND OF THE INVENTION

With IC recorders, a voice signal input from a microphone is converted to digital data by depressing a recording start button, and the data is given a file name and thereafter written to an external memory having an IC memory, which is removably attached thereto, such as Smart Media (registered trademark) or Multi Media Card. Depressing a recording termination button ceases the recording operation.

Further, the file name of digital data to be reproduced is specified and a reproduction start button is depressed to read from the external memory the digital data having the file name specified, the data is converted to an analogue voice signal, and the signal is output as voice from a speaker. Depressing a reproduction termination button terminates the reproduction operation.

For example, in data recording by a tape recorder, an index can be recorded at a desired position of the tape by performing an index recording manipulation during the recording of a series of voice data. In data reproduction, the position at which the index is recorded is searched to skip to the position at which the data is to be reproduced.

However, many of IC recorders prepare a voice file having a predetermined format like a WAVE file for the data recording. Such IC recorders cannot record the index in the voice file, so that there arises the problem that a skip operation cannot be realized.

### SUMMARY OF THE INVENTION

An object of the present invention is to provide a data recording-reproduction device for recording and reproducing data under a predetermined format which device is adapted for realizing a skip operation.

The present invention provides a data recording-reproduction device which is adapted for a data recording operation for converting to digital data voice or image generated continuously on a real time-base axis and writing the data to a memory, and a data reproduction operation for reading the digital data written to the memory and reproducing the data as voice or image. The data recording-reproduction device comprises recording start means and index recording means to be manipulated by the user for the data recording, reproduction start means and index skip means to be manipulated by the user for the data reproduction, recording control means for controlling the data recording operation in response to the manipulation of the recording start means and the index recording means, and reproduction control means for controlling the data reproduction operation in response to the manipulation of the reproduction start means and the index skip means.

The recording control means starts to write the digital data in response to the manipulation of the recording start means, prepares a file name including a file ID number and an index number to give the file name to the digital data, continues to write the digital data in response to the subsequent manipulation of the index recording means, updates the index number included in the file name, and prepares a new file name including the same file ID number and the updated index number to give the file name to the digital data.

Furthermore, the reproduction control means starts to read the digital data having the selected file name in response to the manipulation of the reproduction start means, updates an index number included in the file name in response to the manipulation of the index skip means, and reads digital data having a new file name including the same file ID number and the updated index number.

In recording data by the data recording-reproduction device of the present invention, the index number is sequentially updated while the same file ID number is maintained by manipulating the index recording means at a desired time after the manipulation of the recording start means, to thereby prepare a new file. In preparation of the file, a format of the file to be prepared only by the manipulation of the recording start means is the same as that of a file which is prepared by the conventional device. As a result, a series of voice or image as conventionally written to a memory as a file having a predetermined format will be written to the memory as a plurality of files each having a predetermined format.

In data reproduction subsequent to the above, when the reproduction start means is manipulated and the index skip means is thereafter manipulated, the index number is sequentially updated while maintaining the same file ID number, and digital data having a new file name is read. As a result, the reproduction of a series of voice or image is once interrupted, and the sequence skips to the reproduction of subsequent voice or image recorded as a file having a next index number.

Further stated specifically, the index recording means and the index skip means each comprises a common manipulation button. The manipulation button is operable as the index recording means for the data recording, while as the index skip means for the data reproduction. This can reduce the number of manipulation buttons to thereby provide a more compacted data recording-reproduction device.

Stated more specifically, the device comprises file skip means. The reproduction control means updates the file ID number included in the file name wherein data is being reproduced in response to the manipulation of the file skip means after the manipulation of the reproduction start means, initializes the index number and skips to reading digital data having a new file name wherein the file ID number is updated. This can realize the same skip operation between files as that in the conventional device.

As described above, the data recording-reproduction device of the present invention records and reproduces data under the predetermined format, and realizes a skip operation at a desired position.

### BRIEF DESCRIPTION OF THE DRAWINGS

FIG. 1 is a block diagram showing the construction of an IC recorder of the present invention;

FIG. 2 is a flow chart showing a recording control procedure of the IC recorder;

FIG. 3 is a flow chart showing a reproduction control procedure of the IC recorder;

FIGS. 4(a), (b) and (c) are diagrams describing the file constructions prepared by a recording operation of the IC recorder;

FIG. 5 is a diagram describing a skip operation during the reproduction of the IC recorder.

### DETAILED DESCRIPTION OF EMBODIMENT

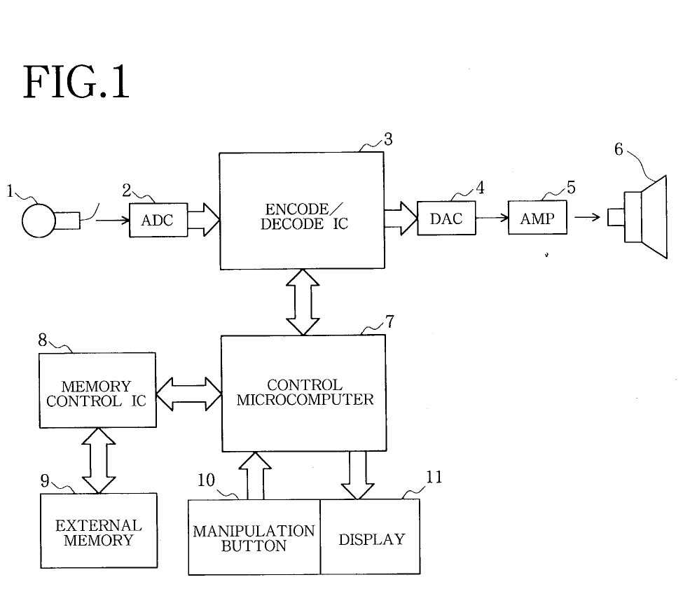

The present invention as applied to an IC recorder will be described below with reference to the drawings. The IC recorder, as shown in FIG. 1, comprises a manipulation button 10 to be manipulated by the user, a display 11 for displaying various information, an external memory 9 removably attached thereto, and is adapted for a recording operation for writing to the external memory 9 voice collected by a microphone 1 as digital data, and a reproduction operation for reading the digital data written to the external memory 9 to output from a speaker 6 as voice.

In recording voice, an AD converter 2 converts a voice signal input from the microphone 1 to digital data, which is further encoded in an encode/decode IC 3, thereafter the encoded data is fed through a control microcomputer 7 to a memory control IC 8, and the data is written to the external memory 9 by the memory control IC 8. On the other hand, in reproducing voice, the digital data read from the external memory 9 by the memory control IC 8 is fed through the control microcomputer 7 to the encode/decode IC 3, and the data is decoded in the encode/decode IC 3. Thereafter a D/A converter 4 converts the data to an analogue voice signal, which is amplified by an amplifier 5, and is then output from the speaker 6 as voice.

The manipulation button 10 includes a recording button for starting recording, a STOP button for terminating recording, an INDEX button for recording an index and skipping between the indexes, a reproduction button for starting reproduction, a SKIP button for skipping between the files as conventionally provided.

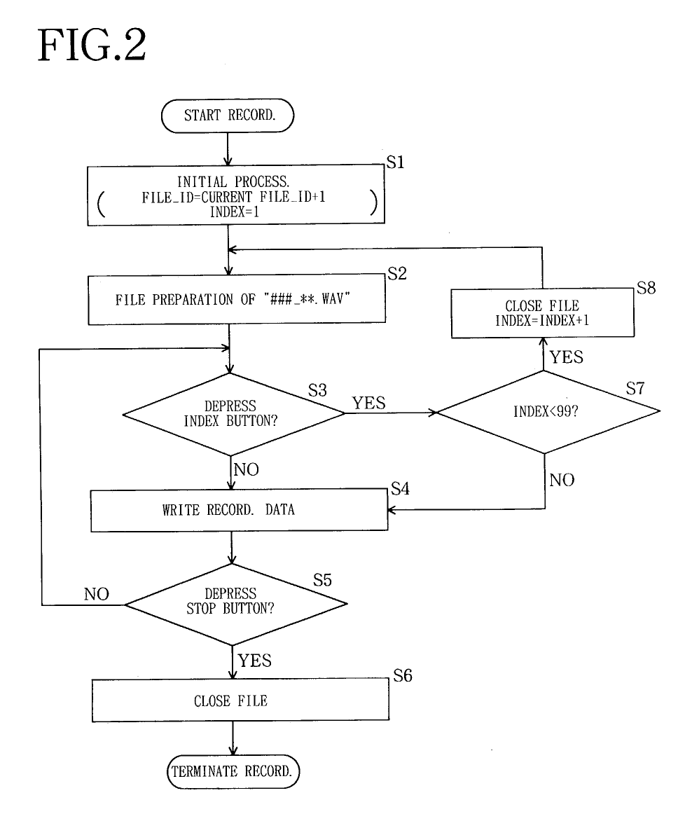

FIG. 2 shows a recording control procedure to be executed by the control microcomputer 7 in response to the manipulation of the INDEX button and STOP button. With this embodiment, a following format is used as a file name.

“###_***.WAV”

A file ID number FILE_ID is entered as for “###”. An index number INDEX is entered as for “***”. “WAV” is the extension showing the WAVE format.

When the recording button is depressed, step S1 executes a predetermined initial processing, i.e., adds one to the file ID number “FILE_ID”, to update the file ID number and set the index number INDEX to one. Next in step S2 a file of “###_***.WAV” is prepared, followed by step S3 wherein an inquiry is made as to whether the INDEX button is depressed. If the answer is negative, step S4 follows to write recording data to the external memory 9. Step S5 thereafter follows to inquire whether the STOP button is depressed. When the answer is negative, the sequence returns to step S3 in which writing the recording data is continued unless the INDEX button and the STOP button are not depressed.

In this process when the answer for step S3 is affirmative by depressing the INDEX button, step S7 follows to inquire whether the index number INDEX is smaller than 99. If the answer is affirmative, step S8 follows to close the file and to advance the index number INDEX. The sequence thereafter returns to step S2 in which the file preparation is repeated. On the other hand, when the answer for step S7 is negative, the index number INDEX is not advanced, followed by step S4 to continue to write the recording data. When the STOP button is thereafter depressed making the answer for step S5 affirmative, step S6 follows to close the file and terminate the recording operation.

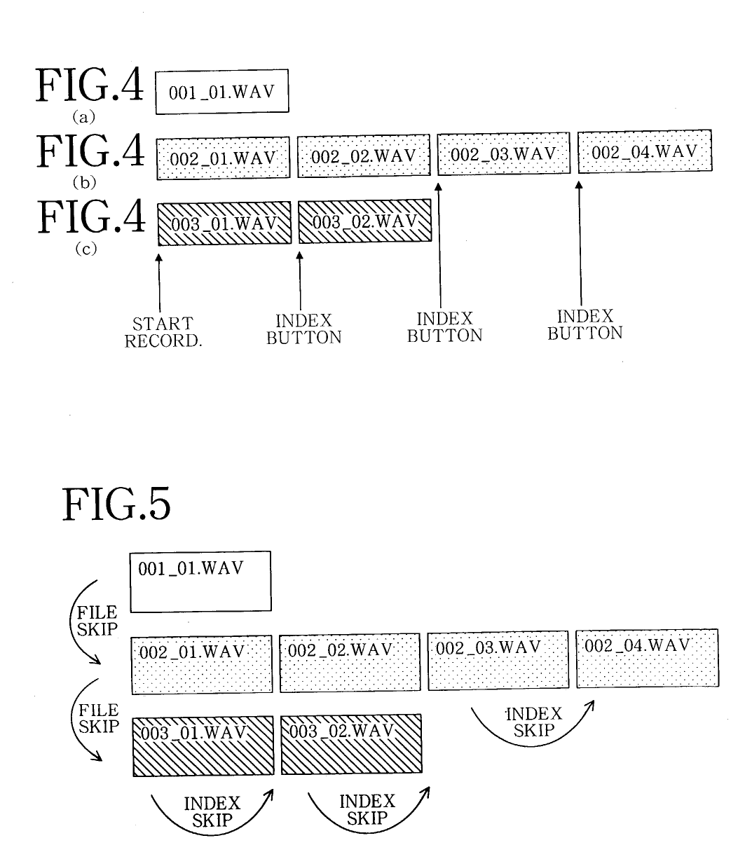

The recording operation described above prepares a plurality of files each having the WAVE format as shown in FIGS. 4(a), 4(b), and 4(c). FIG. 4(a) shows an example wherein the INDEX button is not manipulated after the manipulation of the recording button starts recording, and a file of “001_{—}01.WAV” is prepared for a series of voice data. Shown in FIG. 4(b) is the case wherein the recording described above is once terminated, thereafter new recording is started, and the INDEX button is then manipulated three times. Prepared for a series of voice data are four files of “002_{—}01.WAV”, “002_{—}02.WAV”, “002_{—}03.WAV” and “002_{—}04.WAV”. Shown in FIG. 4(c) is the case wherein the recording described above is further once terminated, thereafter a new recording is started, and the INDEX button is then manipulated once. Prepared for a series of voice data are two files of “003_{—}01.WAV” and “003_{—}02.WAV”.

As described above, with the IC recorder of the present invention, a series of voice is recorded to the external memory 9 as a plurality of files in accordance with the number of times of the manipulation of the INDEX button as shown in FIGS. 4(b) and 4(c). The WAVE format is maintained in these files as in the file prepared only by manipulating the recording button as shown in FIG. 4(a).

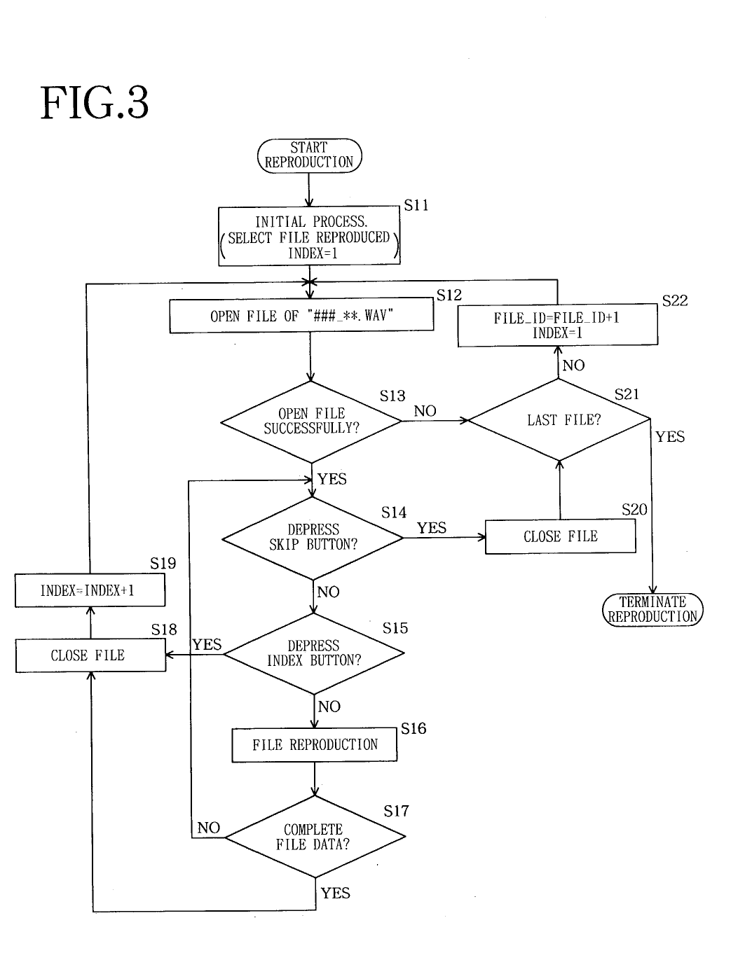

FIG. 3 shows a reproduction control procedure to be executed by the control microcomputer 7 in response to the manipulation of the reproduction button, INDEX button and SKIP button. First in step S11, when the reproduction button is depressed, a predetermined initial processing is executed, i.e., selects a file to be reproduced to set the file ID number FILE_ID and sets the index number INDEX to one. Next in step S12 a file of “###_***.WAV” in the external memory 9 is opened. Subsequently in step S13 an inquiry is made as to whether the file is successfully opened. If the answer is affirmative, step S14 follows to inquire whether the SKIP button is depressed. When the answer is negative, an inquiry is made whether the INDEX button is depressed. If the answer is negative, step S16 follows to reproduce the file opened.

Thereafter in step S17 an inquiry is made whether the file data is completed. If the inquiry is answered in the negative, step S14 follows to continue to reproduce the file unless the SKIP button and the INDEX button are depressed. When the file data is completed to make the answer for step S17 affirmative, step S18 follows to close the file. Then step S19 follows to advance the index number INDEX. The sequence returns to step S12 wherein the next file “###_***.WAV” is opened, and the file reproduction is repeated.

When the INDEX button is depressed during the reproduction of the file to make the answer for step S15 affirmative, step S18 follows to close the file being reproduced. Then step S19 follows to advance the index number INDEX. The sequence thereafter returns to step S12 to open the next file “###_***.WAV”, and the file reproduction is repeated.

When the SKIP button is depressed during the reproduction of the file to make the answer for step S14 affirmative, step S20 follows to close the file being reproduced. In step S21 an inquiry is made whether the file is the last file. When the answer for step S21 is negative, step S22 follows to advance the file ID number FILE_ID and to set the index number INDEX to one. The sequence thereafter returns to step S12 wherein the next file “###_***.WAV” is opened, and the reproduction of the file is repeated. When the answer for step S21 is affirmative, the reproduction operation is terminated.

FIG. 5 describes how a plurality of files shown in FIGS. 4(a), 4(b) and 4(c) are reproduced while skipped according to the reproduction control procedure described above. As shown in FIG. 5, the SKIP button is manipulated while the file of “001_{—}01.WAV” wherein a series of voice data is recorded is reproduced, skipping to the reproduction of the head file of “002_{—}01.WAV” from among four files of “002_{—}01.WAV”, “002_{—}02.WAV”, “002_{—}03.WAV” and “002_{—}04.WAV” wherein a subsequent series of voice data is recorded. Thereafter the three consecutive files of “002_{—}01.WAV”, “002_{—}02.WAV” and “002_{—}03.WAV” are reproduced. When the INDEX button is manipulated during the reproduction of the third file of “002_{—}03.WAV”, the sequence skips to the reproduction of the fourth file of “002_{—}04.WAV”.

Further the SKIP button is manipulated during the reproduction of the head file of “002_{—}01.WAV”, skipping to the reproduction of the head file of “003_{—}01.WAV” from among two files of “003_{—}01.WAV” and “003_{—}02.WAV” wherein a next series of voice data is recorded. Further, when the INDEX button is manipulated during the reproduction of the file of “003_{—}01.WAV”, the sequence skips to the reproduction of the second file of “003_{—}02.WAV”.

As described above, with the IC recorder of the present invention, a series of voice data has the same file ID number FILE_ID, and only the INDEX number is updated when the INDEX button is depressed during the data recording, so that the same reproduction operation as that in the conventional practice can be realized by consecutively reproducing a plurality of files having the same file ID number FILE_ID when the voice data is reproduced, and skipping between the INDEXes can be performed by the manipulation of the INDEX button. Further, with a different series of voice data, skipping between the files as conventionally practiced can be performed by the manipulation of the SKIP button since the file ID number FILE_ID is updated.

Furthermore the WAVE format is maintained in all the files regardless of whether the files are same or different in file ID number FILE_ID and INDEX number, so that editing can be performed with a file unit. For example, even if a given file is deleted from among a plurality of files wherein a series of voice data is recorded, the reproduction of the remaining file will not be disturbed.

The embodiments described above are intended to illustrate the present invention and should not be construed as restricting the invention defined in the appended claims or reducing the scope thereof. Further the devices of the invention are not limited to those of the foregoing embodiments in construction but can of course be modified variously without departing from the spirit of the invention as set forth in the claims.

For example, the present invention is not limited to an audio device like an IC recorder but can be applied also to an image capturing device like a digital video camera.

According to the embodiment described, a series of voice is recorded as a plurality of files to the memory 9 in accordance with the number of manipulation times of the INDEX button but can also be recorded as mere data blocks.

Furthermore, whereas used as the format of the file name are the file ID number and the index number including only numerals, used as the format of the file name can be file identification information and index information including only codes or file identification information and index information including numerals and codes.

What is claimed is:

1. A data recording-reproduction device being adapted for a data recording operation for converting to digital data voice or image generated continuously on a real time-base axis and writing the data to a memory, and a data reproduction operation for reading the digital data written to the memory and reproducing the data as voice or image, the data recording-reproduction device comprising;
recording start means and index recording means to be manipulated by the user for the data recording,
reproduction start means and index skip means to be manipulated by the user for the data reproduction,
recording control means for controlling the data recording operation in response to the manipulation of the recording start means and the index recording means and
reproduction control means for controlling the data reproduction operation in response to the manipulation of the reproduction start means and the index skip means,
the recording control means starting to write the digital data in response to the manipulation of the recording start means, giving data identification information and index information to the digital data, continuing to write the digital data in response to the subsequent manipulation of the index recording means, updating the index information and giving the same data identification information as the data identification information described above and the updated index information to the digital data,
the reproduction control means starting to read the digital data given selected data identification information, updating the index information given to the digital data in response to the subsequent manipulation of the index skip means and reading the digital data given the same data identification information as the data identification described above and the updated index information.

2. A data recording-reproduction device according to claim 1 wherein the index recording means and the index skip means each comprises a common manipulation button, and the manipulation button is operable as the index recording means for the data recording while as the index skip means for the data reproduction.

3. A data recording-reproduction device according to claim 1 wherein the device further comprises recording termination means and reproduction termination means, the recording control means terminates the data recording operation in response to the manipulation of the recording termination means while the reproduction control means terminates the data reproduction operation in response to the manipulation of the reproduction termination means.

4. A data recording-reproduction device according to claim 3 wherein the index recording means and the index skip means each comprises a common manipulation button, and the manipulation button is operable as the index recording means for the data recording while as the index skip means for the data reproduction.

5. A data recording-reproduction device being adapted for a data recording operation for converting to digital data voice or image generated continuously on a real time-base axis and writing the data to a memory, and a data reproduction operation for reading the digital data written to the memory and reproducing the data as voice or image, the data recording-reproduction device comprising;
recording start means and index recording means to be manipulated by the user for the data recording,
reproduction start means and index skip means to be manipulated by the user for the data reproduction,
recording control means for controlling the data recording operation in response to the manipulation of the recording start means and the index recording means and
reproduction control means for controlling the data reproduction operation in response to the manipulation of the reproduction start means and the index skip means,
the recording control means starting to write the digital data in response to the manipulation of the recording start means, preparing a file name including a file ID number and an index number to give the file name to the digital data, continuing to write the digital data in response to the subsequent manipulation of the index recording means, updating the index number included in the file name, and preparing a new file name including the same file ID number and the updated index number to give the file name to the digital data,
the reproduction control means starting to read the digital data having the selected file name in response to the manipulation of the reproduction start means, updating the index number included in the file name in response to the subsequent manipulation of the index skip means, and reading digital data having a new file name including the same file ID number and the updated index number.

6. A data recording-reproduction device according to claim 5 wherein the index recording means and the index skip means each comprises a common manipulation button, and the manipulation button is operable as the index recording means for the data recording while as the index skip means for the data reproduction.

7. A data recording-reproduction device according to claim 5 wherein the device further comprises recording termination means and reproduction termination means, the recording control means terminates the data recording operation in response to the manipulation of the recording termination means while the reproduction control means terminates the data reproduction operation in response to the manipulation of the reproduction termination means.

8. A data recording-reproduction device according to claim 7 wherein the index recording means and the index skip means each comprises a common manipulation button, and the manipulation button is operable as the index recording means for the data recording while as the index skip means for the data reproduction.

9. A data recording-reproduction device according to claim 5 wherein the device further comprises file skip means, the reproduction control means updates the file ID number included in the file name wherein data is being reproduced in response to the manipulation of the file skip means after the manipulation of the reproduction start means, initializes the index number and reads digital data having a new file name wherein the file ID number is updated.

10. A data recording-reproduction device according to claim 9 wherein the index recording means and the index skip means each comprises a common manipulation button, and the manipulation button is operable as the index recording means for the data recording while as the index skip means for the data reproduction.

11. A data recording-reproduction device according to claim 9 wherein the device further comprises recording termination means and reproduction termination means, the recording control means terminates the data recording operation in response to the manipulation of the recording termination means while the reproduction control means terminates the data reproduction operation in response to the manipulation of the reproduction termination means.

12. A data recording-reproduction device according to claim 11 wherein the index recording means and the index skip means each comprises a common manipulation button, and the manipulation button is operable as the index recording means for the data recording while as the index skip means for the data reproduction.

13. A data recording-reproduction device according to claim 5 wherein the file name includes the file ID number and the index number and has an extension showing a file type.
